(19) United States
(12) Patent Application Publication
(10) Pub. No.: US 2026/0336621 A1
(43) Pub. Date: Oct. 29, 2026

(54) VEHICLE CONTROL APPARATUS, VEHICLE CONTROL METHOD, AND VEHICLE CONTROL SYSTEM

(71) Applicant: HITACHI ASTEMO, LTD., Ibaraki (JP)

(72) Inventors: Naoki SHINOHARA, ibaraki (JP); Keisuke SUZUKI, ibaraki (JP)

(21) Appl. No.: 19/107,899

(22) PCT Filed: Aug. 18, 2023
(86) PCT No.: PCT/JP2023/029823

§ 371 Date: Feb. 28, 2025

(30) Foreign Application Priority Data
Sep. 1, 2022 (JP) 2022-138913

(51) Int. Cl. B60W 30/18; B60W 10/08; B60W 10/184; B60W 50/00

(52) U.S. Cl. CPC B60W 30/18109; B60W 10/08; B60W 10/184; B60W 2050/0024; B60W 2050/0054; B60W 2510/184; B60W 2520/10; B60W 2710/083; B60W 2710/18

(57) ABSTRACT

A vehicle control apparatus corrects a control instruction for generating a driving force by a rear motor according to a degree of reliability of a calculation result attributed to a state of a vehicle, in a state that a frictional braking force is generated at the time of deceleration of the vehicle based on a total braking force.

### TECHNICAL FIELD

The present invention relates to a vehicle control apparatus, a vehicle control method, and a vehicle control system.

### BACKGROUND ART

PTL 1 discloses a technique that acquires a physical quantity relating to a speed of a vehicle and a physical quantity relating to a requested braking force required to decelerate the vehicle and generates a driving force by a driving device under a state in which a friction braking force is being generated when the vehicle is to be decelerated based on the physical quantity relating to the requested braking force with the aim of suppressing a pitching fluctuation that occurs just before the vehicle stops.

### CITATION LIST

### Patent Literature

PTL 1: Japanese Patent Application Laid-Open No. 2022-056583

### SUMMARY OF INVENTION

### Technical Problem

However, although the above-described conventional vehicle control apparatus increases the driving force based on an instruction value of the frictional braking force, an error may be generated between the estimated frictional braking force and a braking force actually generated on the vehicle due to, for example, a change in a frictional coefficient according to, for example, a change in the temperature of the brake pad, leading to a failure to effectively realize a smooth vehicle stop under the influence of this error.

One of objects of the present invention is to provide a vehicle control apparatus, a vehicle control method, and a vehicle control system capable of effectively suppressing a pitching fluctuation when a vehicle stops.

### Solution to Problem

According to one aspect of the present invention, a vehicle control apparatus corrects a control instruction for generating a driving force by a driving apparatus according to a degree of reliability of a calculation result attributed to a state of a vehicle and outputs the control instruction, in a state that a frictional braking force is generated at the time of deceleration of the vehicle based on a physical quantity relating to a total braking force.

According to the one aspect of the present invention, a pitching fluctuation when a vehicle stops can be effectively suppressed.

### BRIEF DESCRIPTION OF DRAWINGS

FIG. 1 schematically illustrates an electric vehicle I including a vehicle control system according to a first embodiment.

FIG. 2 is a control block diagram of a rear motor 7 according to the first embodiment.

FIG. 3 is a control block diagram of a total braking torque calculation portion 34 according to the first embodiment.

FIG. 4 is a control block diagram of a control gain calculation portion 35 according to the first embodiment.

FIG. 5 is a control block diagram of an added torque calculation portion 37 according to the first embodiment.

FIG. 6 is a control block diagram of an estimated frictional braking force correction gain calculation portion 33 according to the first embodiment.

FIG. 7 is a control block diagram of a reliability evaluation filter portion 73 according to the first embodiment.

FIG. 8 is a cutoff frequency map based on the magnitude of a frictional braking force.

FIG. 9 is a cutoff frequency map based on the change speed of the frictional braking force.

FIG. 10 is a cutoff frequency map based on a vehicle speed.

FIG. 11 is a control block diagram of a gain conversion portion of a variable cutoff filter 85.

FIG. 12 is a control block diagram of a reliability evaluation gain calculation portion 74 according to the first embodiment.

FIG. 13 is a reliability evaluation gain map based on the magnitude of the frictional braking force.

FIG. 14 is a reliability evaluation gain map based on the change speed of the frictional braking force.

FIG. 15 is a reliability evaluation gain map based on a pad temperature change.

FIG. 16 illustrates time charts of the vehicle speed, a G sensor value, a brake hydraulic pressure, and a pad μ, indicating an example of the operation of the reliability evaluation filter portion 73 according to the first embodiment.

FIG. 17 illustrates time charts of the vehicle speed, the G sensor value, the brake hydraulic pressure, the pad μ, and a motor torque, indicating an example of the operation of the reliability evaluation gain calculation portion 74 according to the first embodiment.

### DESCRIPTION OF EMBODIMENTS

### First Embodiment

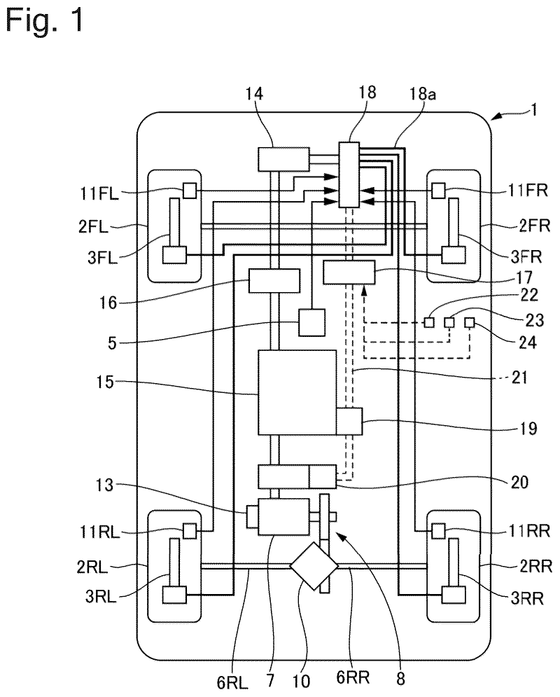

FIG. 1 schematically illustrates an electric vehicle 1 including a vehicle control system according to a first embodiment.

The electric vehicle 1 includes front wheels 2FL and 2FR and rear wheels 2RL and 2RR, and frictional brakes (frictional braking apparatuses) 3FL, 3FR, 3RL, and 3RR mounted on the respective wheels and configured to generate frictional braking forces on the respective wheels (hereinafter, the frictional brakes of the respective wheels will also be collectively referred to as a frictional brake 3).

The electric vehicle 1 includes a rear motor (a driving apparatus) 7, which outputs a torque to the rear wheels 2RL and 2RR. The rear wheels 2RL and 2RR will also be collectively referred to as a drive wheel 2. Power is transmitted between the rear motor 7 and the rear wheels 2RL and 2RR via a reducing gear 8, a differential 10, and rear axles 6RL and 6RR.

The wheels 2FL, 2FR, 2RL, and 2RR include wheel speed sensors 11FR, 11FL, 11RL, and 11RR, which detect wheel speeds, respectively. The rear motor 7 includes a rear-wheel resolver 13, which detects a motor speed (a motor rotational speed). Further, the electric vehicle 1 includes a G sensor 5, which detects a longitudinal acceleration (hereinafter also simply referred to as an acceleration) of the vehicle.

The frictional brake 3 generates the braking force based on a frictional force by pressing brake pads against a brake rotor integrally rotating with each wheel in a direction along a rotational axis of each wheel. The frictional brake 3 according to the first embodiment will be described as being configured to press the brake pads using a wheel cylinder actuated by a brake hydraulic pressure, but may be configured to press the brake pads via, for example, a ball screw mechanism driven by an electric motor and is not especially limited.

The electric vehicle I includes a low-voltage battery 14 and a high-voltage battery 15. The low-voltage battery 14 is, for example, a lead storage battery. The high-voltage battery 15 is, for example, a lithium ion battery or a nickel hydrogen battery. The high-voltage battery 15 is charged by electric power whose voltage is increased by a DC-DC converter 16.

The electric vehicle 1 includes a vehicle control apparatus (a control portion) 17, a brake control apparatus 18, a rear motor control apparatus 20, and a battery control apparatus 19. These control apparatuses 17, 18, and 20 share information with one another via a CAN bus 21.

The vehicle control apparatus 17 acquires information from various kinds of sensors such as the rear-wheel resolver 13, an accelerator pedal sensor 22, which detects an accelerator operation amount, a brake sensor 23, which detects a brake operation amount, and a gear position sensor 24, and comprehensively controls the vehicle. The vehicle control apparatus 17 outputs a driver request torque that the rear motor 7 should output according to a request distribution torque in response to a request torque according to an accelerator operation, a brake operation, or the like of the driver.

The brake control apparatus 18 acquires information from various kinds of sensors such as the brake sensor 23 to set a target braking torque, which is a torque converted value of a target braking force of the vehicle, to generate the brake hydraulic pressure required for each wheel according to the target braking torque to output it to the frictional brake 3 via a hydraulic pipe 18a.

The battery control apparatus 19 monitors a charged/discharged state of the high-voltage battery 15 and a cell constituting the high-voltage battery 15. The battery control apparatus 19 calculates a battery request torque limit value based on the charged/discharged state of the high-voltage battery 15 or the like. The battery request torque limit value is a maximum torque allowed for the rear motor 7. For example, when the charged capacity of the high-voltage battery 15 is lowered, the battery request torque limit value is set to a smaller value than normal.

The rear motor control apparatus 20 controls electric power to supply to the rear motor 7 based on a rear request torque.

The electric vehicle 1 according to the first embodiment performs anti-jerk control of causing the rear motor 7 to output a driving torque corresponding to a total braking torque determined by estimating a braking torque actually generated on the vehicle when the vehicle stops, with the aim of suppressing an unpleasant vibration of the vehicle when the vehicle stops to thus ease fatigue of a passenger. As a result, a longitudinal jerk (jolt) that occurs when the vehicle stops with a predetermined brake operation amount can be reduced by approximately 68% compared to when the anti-jerk control is absent. In other words, the vehicle can smoothly stop even in the absence of a skillful brake operation.

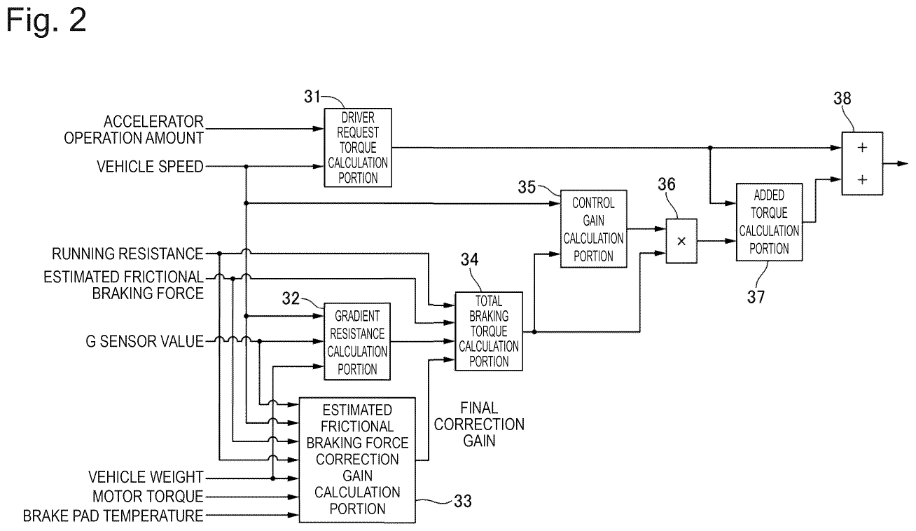

FIG. 2 is a control block diagram of the rear motor 7 according to the first embodiment.

A driver request torque calculation portion 31 calculates the driver request torque based on the accelerator operation amount and a vehicle speed. The wheel speed is determined by any method as appropriate based on each wheel speed detected by each of the wheel speed sensors 11FR, 11FL, 11RL, and 11RR, but is determined by referring to the motor speed detected by the rear-wheel resolver 13 under a low speed.

A gradient resistance calculation portion 32 calculates gradation resistance, which is resistance acting on the vehicle due to a gradient of a road surface, based on the vehicle speed, the G sensor value, and a vehicle weight. More specifically, the gradient resistance calculation portion 32 determines an estimated gradient acceleration generated due to the gradient based on a deviation between a differential value of the vehicle speed and the G sensor value, and calculates the gradient resistance based on the estimated gradient acceleration generated due to the gradient and the vehicle weight.

An estimated frictional braking force correction gain calculation portion 33 calculates a final correction gain for correcting an estimation error of an estimated frictional braking force that occurs along with a change in a pad μ (a frictional coefficient) based on the G sensor value, the vehicle speed, the estimated frictional braking force, running resistance, the vehicle weight, a motor torque, and a brake pad temperature. When the pad μ changes due to, for example, a temperature change or a humidity change, the estimated frictional braking force deviates from the braking force actually generated on the vehicle by the brake. Therefore, the pad μ is estimated, and a gain for correcting the estimated frictional braking force (a torque converted value thereof) is calculated to cancel out an error in an estimated pad μ from a nominal value of the pad μ.

The estimated frictional braking force is calculated as a sum of the respective estimated frictional braking forces of the wheels. The estimated frictional braking force Bi of each wheel is calculated using the following equation (1).

estimated frictional braking force Bi of each wheel=brake hydraulic pressure×cylinder area×brake effective radius×pad μ (nominal value) . . . (1)

In this case, the nominal value of the pad μ is kept constant while the vehicle is running once it is set. The nominal value is set by acquiring a temperature-μ characteristic of the brake pad as a map in advance and referring to the map. The temperature of the brake pad when the nominal value is calculated may be an external temperature when the vehicle starts running, or a predefined temperature (for example, 20 °C) may be used.

The running resistance may be determined by acquiring a change in the running resistance with respect to a change in the vehicle weight or the vehicle speed in advance and calculating the running resistance based thereon, or estimating the running resistance.

The estimated frictional braking force may be estimated based on a driver's stroke amount of the brake pedal instead of the brake hydraulic pressure.

The details of the estimated frictional braking force correction gain calculation portion 33 will be described below.

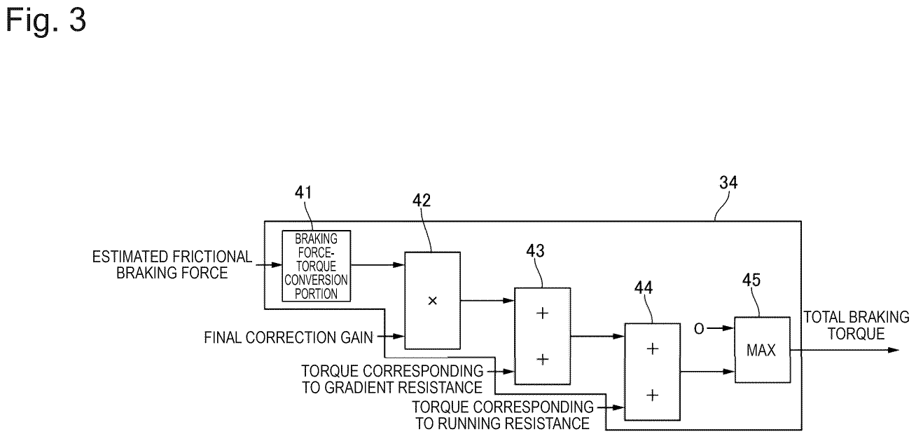

A total braking torque calculation portion 34 calculates the total braking torque based on the running resistance, the estimated frictional braking force, the gradient resistance, and the final correction gain. FIG. 3 is a control block diagram of the total braking torque calculation portion 34 according to the first embodiment. A braking force-torque conversion portion 41 converts the estimated frictional braking force into an estimated frictional braking torque. A multiplier 42 calculates an after-correction estimated frictional braking torque resulting from correcting the estimation error that occurs along with the change in u of the brake pad by multiplying the estimated frictional braking torque by the final correction gain. A first adder 43 and a second adder 44 add a torque corresponding to the gradient resistance and a torque corresponding to the running resistance to the after-correction estimated frictional braking torque. A limiter 45 compares a value resulting from adding the torque corresponding to the gradient resistance and the torque corresponding to the running resistance to the after-correction estimated frictional braking torque, and zero, and outputs one of them that has a larger value as the total braking torque.

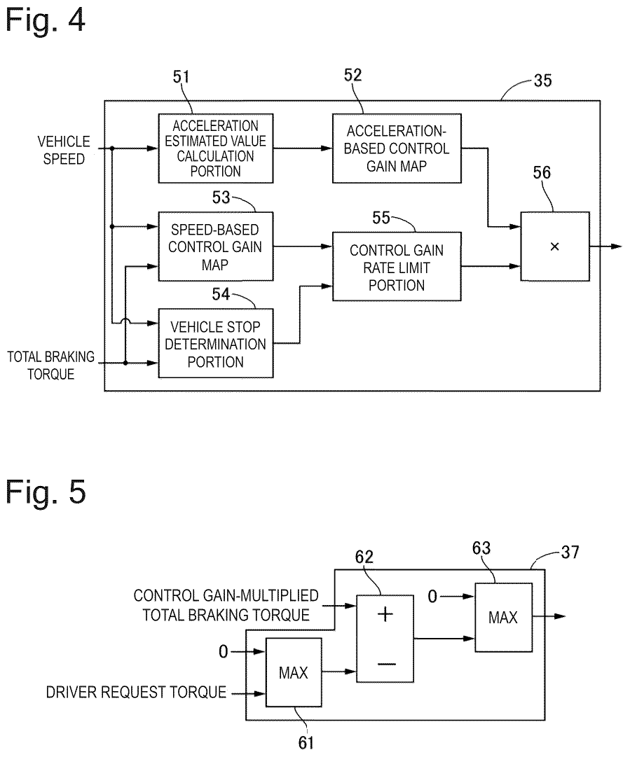

A control gain calculation portion 35 calculates a control gain based on the vehicle speed and the total braking torque. FIG. 4 is a control block diagram of the control gain calculation portion 35 according to the first embodiment. An acceleration estimated value calculation portion 51 calculates an acceleration by differentiating the vehicle speed. An acceleration-based control gain map 52 sets an acceleration-based control gain according to the acceleration. The acceleration-based control gain map 52 sets the acceleration-based control gain to 1(100 %) if a deceleration smaller than a predefined value x2 (G) as the absolute value is generated, while gradually reducing the acceleration-based control gain as the absolute value of the deceleration increases if a deceleration equal to or greater than the predefined value x2 (G) as the absolute value is generated. The minimum value of the acceleration-based control gain is set to zero (0%). This setting can prevent the torque from being added at the time of sudden braking. It goes without saying that it is more desirable to secure the braking force than suppressing a vibration in the pitching direction at the time of sudden braking.

A speed-based control gain map 53 sets a speed-based control gain based on a three-dimensional map according to the vehicle speed and the total braking torque. The speed-based control gain has a characteristic of linearly reducing as the total braking torque reduces only in a predetermined region where the total braking torque is around zero, and being kept at a maximum value 1 in most regions exceeding the predetermined region. The maximum value may be set to a positive value different from 1. Further, the speed-based control gain is set so as to linearly increase as the vehicle speed reduces. Further, the speed-based control gain is set in such a manner that a vehicle speed at which the value rises from zero (a gain increase start speed) increases as the total braking torque increases. In other words, the speed-based control gain has such a characteristic that the vehicle speed at which an anti-jerk control instruction intervenes (the vehicle speed at which the generation of a driving force by the anti-jerk control is started) increases as the total braking torque increases.

A vehicle stop determination portion 54 inputs the vehicle speed, the total braking torque, the vehicle weight, and the estimated frictional braking force, and clears a vehicle stop determination flag (=0) unless a vehicle stop time is zero and sets the vehicle stop determination flag (==1) when the vehicle stop time becomes zero.

A control gain rate limit portion 55 limits the speed of a change in the speed-based control gain on an increase side and a reduction side. Further, when the vehicle stop determination flag is set (=1), the control gain rate limit portion 55 changes the change speed limit value on the reduction side used until that.

A multiplier 56 outputs a value resulting from multiplying the acceleration-based control gain by the speed-based control gain as the final control gain.

Referring back to FIG. 2, a multiplier 36 calculates a control gain-multiplied total braking torque by multiplying the total braking torque by the control gain.

An added torque calculation portion 37 calculates an added torque as an anti-jerk control torque based on the driver request torque and the control gain-multiplied total braking torque. FIG. 5 is a control block diagram of the added torque calculation portion 37 according to the first embodiment. A limiter 61 compares the driver request torque and zero, and outputs one of them that has a larger value. A comparator 62 subtracts the output of the limiter 61 from the control gain-multiplied total braking torque. A limiter 63 compares the output of the comparator 62 and zero, and outputs one of them that has a larger value as the added torque.

An adder 38 sets an after-addition torque resulting from adding the added torque to the driver request torque as the rear request torque.

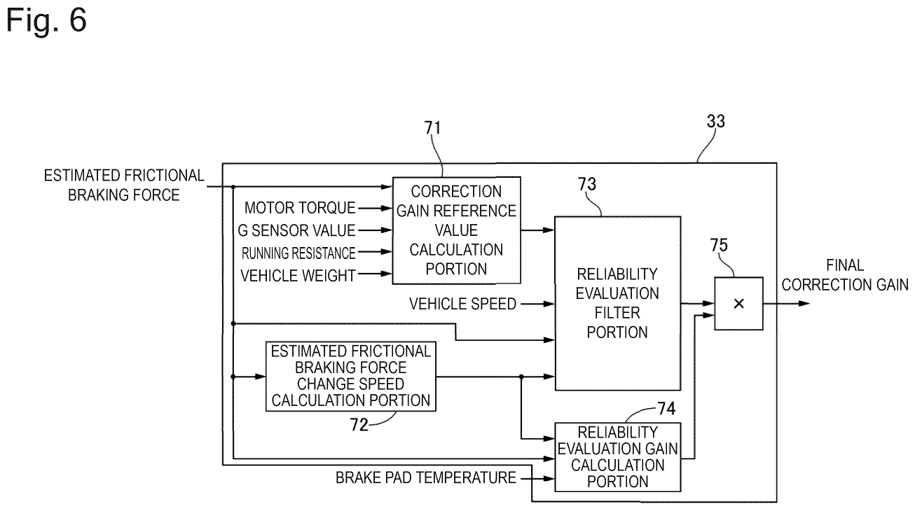

FIG. 6 is a control block diagram of the estimated frictional braking force correction gain calculation portion 33 according to the first embodiment.

A correction gain reference value calculation portion 71 calculates a correction gain reference value by referring to the following equation (2) based on the estimated frictional braking force, the motor torque, the G sensor value, the running resistance, and the vehicle weight.

correction gain reference value=(G sensor value×vehicle weight−braking/driving force corresponding to motor torque−running resistance)/estimated frictional braking force . . . (2)

A final torque instruction value of the vehicle control apparatus or a final torque instruction value of the inverter may be used as the motor torque.

The differential value of the vehicle speed may be used instead of the G sensor value. In this case, because the differential value of the vehicle speed also contains the influence of the gradient resistance, the numerator portion on the right side of the equation (2) is modified in the following manner.

(differential value of vehicle speed×vehicle weight−braking/driving force corresponding to motor torque−running resistance−gradient resistance)

Further, the pitch angle of the vehicle affects the longitudinal acceleration sensor value, and therefore the vehicle control apparatus 17 may be configured to detect or estimate the pitch angle of the vehicle and take it into consideration when calculating the correction gain reference value or the gradient resistance.

An estimated frictional braking force change speed calculation portion 72 calculates a change speed of the estimated frictional braking force by differentiating the estimated frictional braking force.

A reliability evaluation filter portion 73 evaluates reliability (calculates a degree of reliability) of the correction gain reference value based on the vehicle speed, the estimated frictional braking force, and the change speed of the estimated frictional braking force, and corrects the correction gain reference value according to the result of the evaluation. The degree of reliability refers to a degree of how high the reliability of the correction gain reference value is (a dispersion of estimation accuracy or expected estimation accuracy).

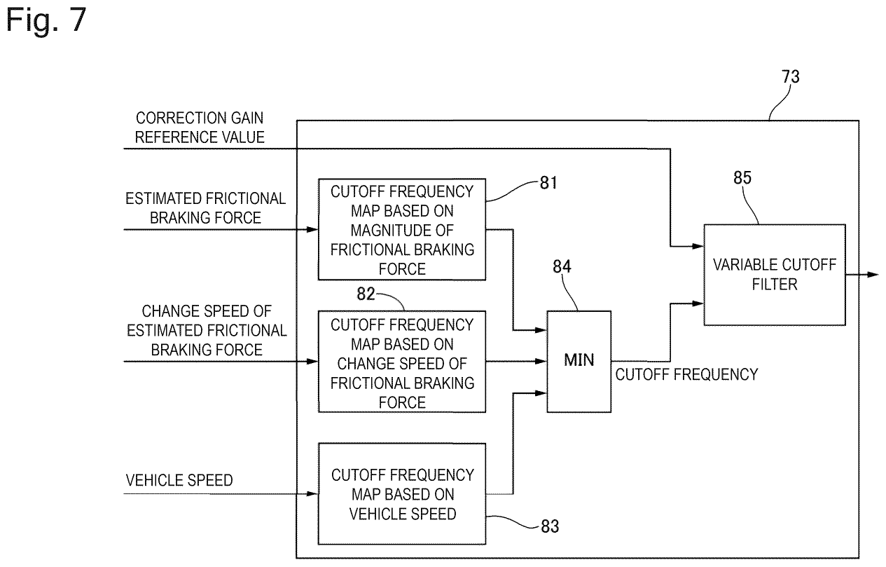

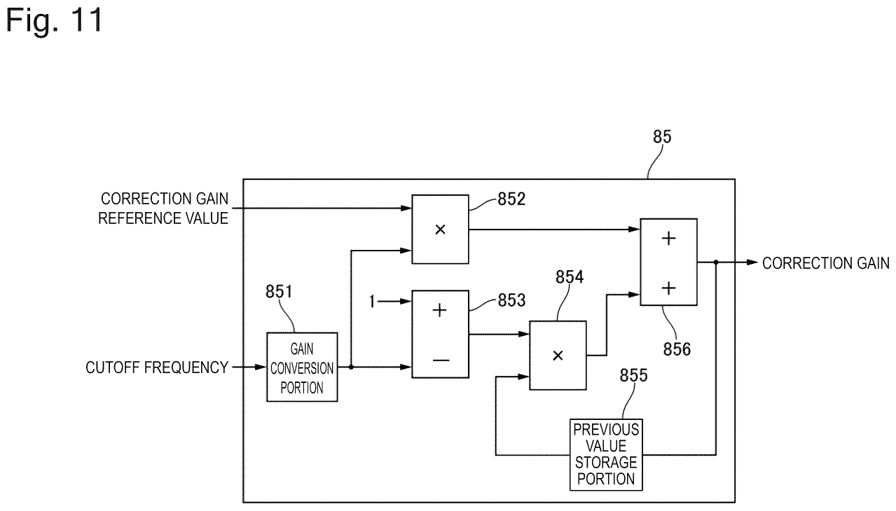

FIG. 7 is a control block diagram of the reliability evaluation filter portion 73 according to the first embodiment. The reliability evaluation filter portion 73 uses, for example, a variable cutoff filter 85 whose response characteristic is variable as illustrated in FIG. 11 to realize an evaluation with weight placed on the present correction gain reference value in a section where the correction gain reference value has high reliability, and on an output value (a correction gain) of the reliability evaluation filter instead of the present correction gain reference value in a section where the correction gain reference value has low reliability. In this case, the smallest of respective output values from frequency maps 81 to 83 in a prior stage is used as the response characteristic of the variable cutoff filter 85. Fig. Il is a control block diagram of a gain conversion portion of the variable cutoff filter 85. The gain conversion portion 851 converts the cutoff frequency determined by these frequency maps 81 to 83 into a gain according thereto. A first multiplier 852 multiplies the correction gain reference value by the gain. A comparator 853 subtracts the gain from 1. A second multiplier 854 multiplies the output of the comparator 853 by a previous output value (correction gain) of the variable cutoff filter 85. A previous value storage portion 855 stores the previous output value of the variable cutoff filter 85. An adder 856 outputs a correction gain resulting from multiplying the output value of the first multiplier 852 and the output value of the second multiplier 854 together. In the present example, the variable cutoff filter 85 has characteristics similar to an LPF (Low Pass Filter) and can further have a filter configuration operable to store the previous output value of the variable cutoff filter 85 by outputting zero as the output value of the gain conversion portion when the cutoff frequency is set to zero, and therefore can calculate the correction gain while appropriately changing the characteristic of response to the correction gain reference value estimated in the present control cycle according to the reliability.

The cutoff frequency map 81 based on the magnitude of the frictional braking force is a map for estimating the correction gain while placing weight on a value estimated in a section where a disturbance or the like unable to be sufficiently reflected in the equation is expected to be less influential. As the frictional braking force reduces, an acceleration generated due to a disturbance unable to be reflected in the equation becomes relatively more influential relative to an acceleration generated due to the frictional braking force included in the G sensor value. As a result, an error may increase between a true value that should be actually corrected and the correction gain reference value estimated using the equation (2).

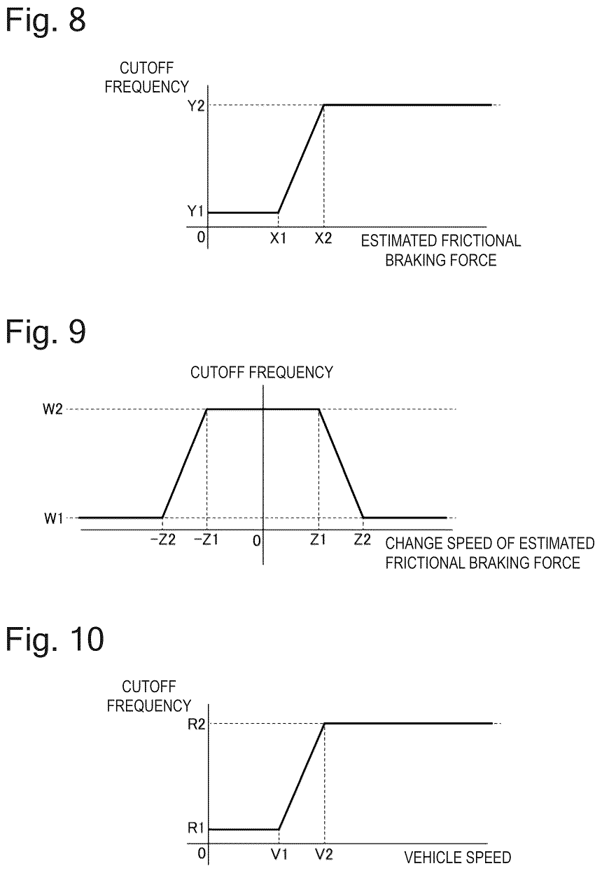

In light thereof, the cutoff frequency map 81 based on the magnitude of the frictional braking force raises a first cutoff frequency Y as the estimated frictional braking force increases. As illustrated in FIG. 8, the first cutoff frequency Y is set to a minimum value Y1 when the estimated frictional braking force is smaller than X1 and to a maximum value Y2 when the estimated frictional braking force exceeds X2, and is set so as to increase as the estimated frictional braking force increases when the estimated frictional braking force is equal to or greater than X1 and equal to or smaller than X2. Further, as described above, an error in the estimation of the correction gain reference value may increase under the influence of a disturbance unable to be sufficiently reflected in the equation when the estimated frictional braking force is small. Therefore, the cutoff frequency is lowered when the estimated frictional braking force reaches or falls below a predetermined estimated frictional braking force. Y1 is assumed to be a non-zero value in the present example, but may be zero.

The cutoff frequency map 82 based on the change speed of the frictional braking force is a map for estimating the correction gain while placing weight on a value estimated in a section where a response delay of the G sensor 5 is expected to be less influential. Because the G sensor 5 is mounted on the sprung side of the vehicle, a time lag occurs until the G sensor value is detected even when the frictional braking force is actually generated. Due to that, when the change speed of the frictional braking force is high, an increase in the frictional braking force causes an increase in the denominator term in the equation (2) but an increase in the G sensor value portion in the numerator progresses slowly, and therefore an error increases in the estimation of the correction gain reference value. Therefore, when such a response delay is expected to occur, the correction gain is estimated with weight placed on the previous output value of the variable cutoff filter. Using pseudo differential to differentiate the vehicle speed or removing sensor noise or the like also involves an element causing a delay such as a filter, thereby being subjected to a response delay behind the increase in the frictional braking force. As described above, it is highly likely that the response delay of the sensor increases and an error from the true value increases as the change speed of the frictional braking force increases, and therefore the cutoff frequency map 82 based on the change speed of the frictional braking force raises a second cutoff frequency W as the change speed of the estimated frictional braking force reduces.

As illustrated in FIG. 9, the second cutoff frequency W is set to a minimum value W1 when the absolute value of the change speed of the estimated frictional braking force exceeds |Z2| and to a maximum value W2 when the absolute value of the change speed of the estimated frictional braking force is lower than |Z1|, and is set so as to reduce as the absolute value of the change speed of the estimated frictional braking force increases when the absolute value of the change speed of the estimated frictional braking force is equal to or higher than |Z| and equal to or lower than |Z2|. When the change speed of the estimated frictional braking force is high, a response delay may occur in the output value of the G sensor 5 mounted on the sprung side of the vehicle behind the change in the estimated frictional braking force under the influence of a spring-mass-damper system of the suspension. In light thereof, the second cutoff frequency W is set to have such a characteristic that the cutoff frequency reduces to place further heavy weight on the previous output value of the variable cutoff filter when the estimated frictional braking force changes rapidly. W1 is assumed to be a non-zero value in the present example but may be zero, and, further, the second cutoff frequency W is set to have a characteristic horizontally symmetric about zero but may be set to have an asymmetric characteristic.

The cutoff frequency map 83 based on the vehicle speed estimates the correction gain while placing weight on the previous output value of the variable cutoff filter when the vehicle speed is low. This is because the brake converts motion energy into thermal energy, and therefore the state of the brake pad is less likely to change even with a braking force applied when the vehicle speed is low. The cutoff frequency map 83 based on the vehicle speed raises a third cutoff frequency R as the vehicle speed increases. As illustrated in FIG. 10, the third cutoff frequency R is set to a minimum value R1 when the vehicle speed is lower than V1 and to a maximum value R2 when the vehicle speed exceeds V2, and is set so as to increase as the vehicle speed increases when the vehicle speed is equal to or higher than V1 and equal to or lower than V2. When the vehicle speed is low, the state of the brake pad is less likely to change, and, further, the anti-jerk control intervenes according to the reduction in the vehicle speed. When the motor torque increases, the response of the G sensor value is delayed behind the change in the motor torque similarly to when the change speed of the frictional braking force is high, and an error may increase in the estimation of the correction gain reference value. Therefore, the cutoff frequency is lowered so as to be able to estimate the correction gain while placing weight on the previous output value of the variable cutoff filter according to the reduction in the speed. In this case, VI may be, for example, the highest vehicle speed at which the anti-jerk control starts intervening, which is predetermined in the gain characteristics of the anti-jerk control determined according to the total braking force and the speed, or may be another speed. Further, RI may be zero.

A limiter 84 outputs a cutoff frequency having the smallest value among the first cutoff frequency Y, the second cutoff frequency W, and the third cutoff frequency R as the cutoff frequency.

The variable cutoff filter 85 performs filter processing on the correction gain reference value according to the cutoff frequency output from the limiter 84.

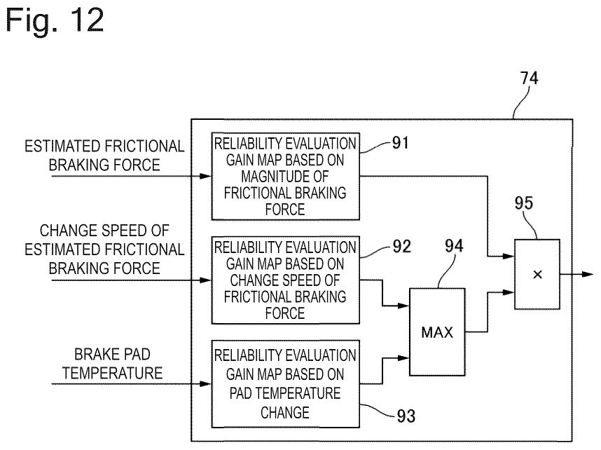

Referring back to FIG. 6, a reliability evaluation gain calculation portion 74 calculates a reliability evaluation gain for correcting the output value of the reliability evaluation filter portion 73 based on the estimated frictional braking force, the change speed of the estimated frictional braking force, and the brake pad temperature. The reliability evaluation gain is a gain for lowering the final correction result when the output of the reliability evaluation filter portion 73 is not reliable so much or when strong intervention by the anti-jerk control is unnecessary. The vehicle control apparatus 17 may be configured to store the reliability evaluation gain calculated until that when the vehicle runs at a low speed (for example, 1 km/h or lower). FIG. 12 is a control block diagram of the reliability evaluation gain calculation portion 74 according to the first embodiment.

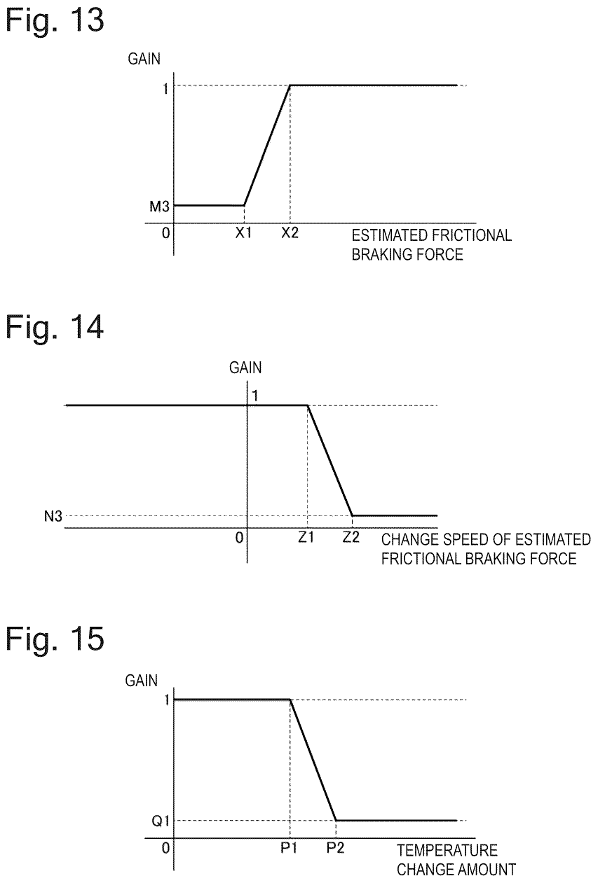

A reliability evaluation gain map 91 based on the magnitude of the frictional braking force raises a first reliability evaluation gain M as the estimated frictional braking force increases. As illustrated in FIG. 13, the first reliability evaluation gain M is set to a minimum value M3 when the estimated frictional braking force is smaller than X1 and to a maximum value of 1 when the estimated frictional braking force exceeds X2, and is set so as to increase as the estimated frictional braking force increases when the estimated frictional braking force is equal to or greater than X1 and equal to or smaller than X2. When the estimated frictional braking force is small, a creep torque and a braking force generated on the vehicle are highly likely to be close to each other, and the pitching amount or the like of the vehicle is small. Therefore, it is expected that the ride comfort is not largely affected even without the intervention by the anti-jerk control. However, an error is highly likely to increase in the estimation of the correction gain under the influence of a disturbance or the like, and therefore the gain is lowered to avoid an accidental considerable increase in the braking distance.

A reliability evaluation gain map 92 based on the change speed of the frictional braking force raises a second reliability evaluation gain N as the change speed of the frictional braking force reduces. As illustrated in FIG. 14, the second reliability evaluation gain N is set to a minimum value N3 when the change speed of the estimated frictional braking force exceeds Z2 and to a maximum value of 1 when the change speed of the estimated frictional braking force is lower than Z1, and is set so as to increase as the change speed of the estimated frictional braking force reduces when the change speed of the estimated frictional braking force is equal to or higher than ZI and equal to or lower than Z2. When the frictional braking force changes rapidly, the update by the reliability evaluation filter portion 73 may be stopped lest the estimation is worsened, and therefore an error may be generated from the estimated value yielded until that when the brake pedal is further increasingly pressed. Therefore, when the estimated frictional braking force increases at a predetermined or higher speed, the second reliability evaluation gain N is lowered because of a possibility of a considerable change from the estimation result yielded until that. When the pressed brake pedal is returned back, it can be expected that, for example, an increase in the brake pad temperature does not occur and it can be considered that the estimated value does not largely change from the estimation result yielded until that (the previous output value of the reliability evaluation filter), and therefore the second reliability evaluation gain is set to 1 in the present embodiment. However, the map may be modified so as to have a characteristic of lowering the second reliability evaluation gain when the change speed of the estimated frictional braking force is high due to the return of the pressed brake pad. Further, the gain is determined by referring to only the change speed of the frictional braking force in the present embodiment, but the map may be modified into a three-dimensional map that refers to the change speed of the frictional braking force and the vehicle speed and lowers the gain when the vehicle speed is a predetermined value or higher and the change speed of the frictional braking force is high.

A reliability evaluation gain map 93 based on the pad temperature change raises a third reliability evaluation gain Q as the amount of the pad temperature change reduces compared to the brake pad temperature detected at the time of the previous frictional braking. As illustrated in FIG. 15, the third reliability evaluation gain Q is set to a minimum value Q1 when the pad temperature change exceeds P2 and to a maximum value of 1 when the pad temperature change is smaller than P1, and is set so as to increase as the pad temperature change reduces when the pad temperature change is equal to or larger than P1 and equal to or smaller than P2. When the pad temperature change is small, the correction gain estimated at the time of the previous braking is highly reliable, and therefore the gain is raised. When the pad temperature change is large, the previous value is less reliable, and therefore the gain is lowered. The pad temperature may be acquired using a sensor, or an estimated value may be used as the pad temperature. Further, a final pad temperature at the previous frictional braking may be used as the brake pad temperature detected at the time of the previous frictional braking.

A limiter 94 outputs one of the second reliability evaluation gain N and the third reliability evaluation gain Q that has a larger value.

A multiplier 95 outputs a value resulting from multiplying the first reliability evaluation gain M by the output value of the limiter 94 as the reliability evaluation gain.

Referring back to FIG. 6, a multiplier 75 outputs a value resulting from multiplying the output value of the reliability evaluation filter portion 73 by the reliability evaluation gain as the final correction gain.

Next, advantageous effects of the first embodiment will be described.

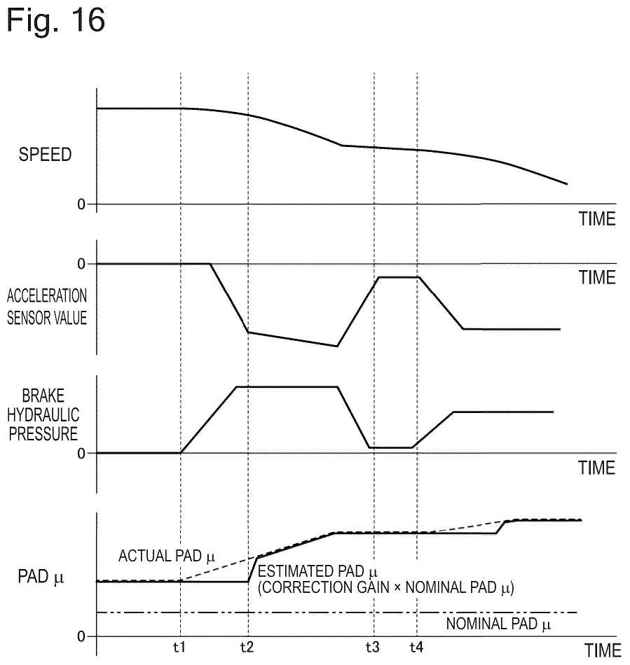

FIG. 16 illustrates time charts of the vehicle speed, the G sensor value, the brake hydraulic pressure, and the pad μ, indicating an example of the operation of the reliability evaluation filter portion 73 according to the first embodiment.

In a section from time t1 to t2, the hydraulic pressure changes rapidly, and an error in the estimated pad μ may increase under the influence of, for example, a delay in the G sensor value. Therefore, the correction gain is updated with heavier weight placed on the previous output value of the variable cutoff filter than the present correction gain reference value. In the case of FIG. 16, the cutoff frequency is set to zero to store the previous value.

In a section from time t3 to t4, the brake hydraulic pressure is low and the frictional braking force is weak. Therefore, the estimation error may increase due to a relative increase in the influence of a disturbance, a sensor error, and the like unable to be sufficiently taken into consideration compared to the influence of the frictional braking force contained in the vehicle deceleration. Therefore, the correction gain is updated with heavier weight also placed on the previous output value of the variable cutoff filter in this case.

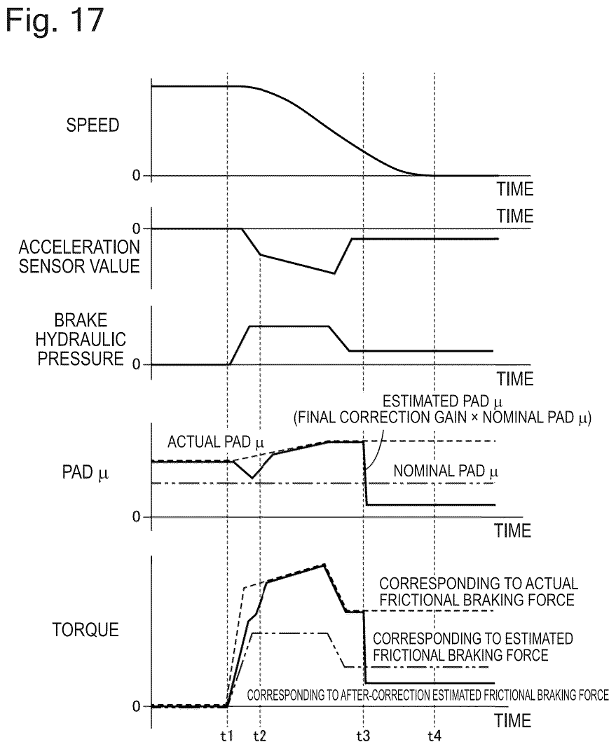

FIG. 17 illustrates time charts of the vehicle speed, the G sensor value, the brake hydraulic pressure, the pad μ, and the motor torque, indicating an example of the operation of the reliability evaluation gain calculation portion 74 according to the first embodiment.

In the section from time t1 to t2, the hydraulic pressure changes rapidly, and the reliability evaluation filter portion 73 may stop the update. Therefore, the after-correction estimated frictional braking force is lowered.

In the section from time t3 to t4, the frictional braking force is weak, and therefore the ride comfort is less likely to be impaired even without strong intervention by the anti-jerk control. Therefore, the after-correction estimated frictional braking force is lowered also in consideration of a possibility that an error may be contained in the estimated pad μ.

In this manner, the vehicle control apparatus 17 according to the first embodiment corrects the control instruction to be output to generate the driving force by the rear motor 7 (the final correction gain when calculating the total braking torque to determine the added torque) according to the degree of reliability of the calculation result attributed to the state of the vehicle in a state that the frictional braking force is generated, at the time of deceleration of the vehicle based on the total braking torque. This allows the vehicle control apparatus 17 to output the added torque less affected by the estimation error in the frictional braking force from the actual braking force in the anti-jerk control, thereby effectively realizing, for example, suppression of a pitching fluctuation when the vehicle stops.

The vehicle control apparatus 17 corrects the control instruction according to the degree of reliability of the calculation result attributed to the state of the vehicle that includes at least the vehicle speed, the physical quantity relating to the frictional braking force, and the temperature of the frictional brake 3. The error between the true value that should be corrected and the correction gain reference value largely changes according to the vehicle speed, the frictional braking force, and the temperature of the frictional brake 3 in the anti-jerk control, and therefore the influence of the estimation error in the frictional braking force can be further effectively suppressed in the anti-jerk control by correcting the control instruction according to the degree of reliability determined in consideration of them.

The vehicle control apparatus 17 determines the final correction gain by multiplying the output value of the reliability evaluation filter portion 73 resulting from correcting the predetermined correction gain reference value according to the degree of reliability of the calculation result attributed to the speed of the vehicle and the degree of reliability of the calculation result attributed to the physical quantity relating to the frictional braking force by the reliability evaluation gain calculated by the reliability evaluation gain calculation portion 74 based on the reliability evaluation gain set according to the degree of reliability of the calculation result attributed to the physical quantity relating to the frictional braking force and the reliability evaluation gain set according to the degree of reliability of the calculation result attributed to the physical quantity relating to the temperature of the frictional brake 3, and corrects the control instruction based on the final correction gain. This allows the vehicle control apparatus 17 to realize the estimation with weight placed on the present correction gain reference value in the section where the reliability is high and on the previous output value of the variable cutoff filter in the section where the reliability is low, thereby further effectively suppressing the influence of the estimation error. Further, when the output of the reliability evaluation filter portion 73 is less reliable or when strong intervention of the anti-jerk control is unnecessary, an accidental considerable increase in the braking distance can be suppressed by lowering the final correction gain.

The vehicle control apparatus 17 determines the final correction gain by multiplying the output value resulting from filtering the predetermined correction gain reference value through the variable cutoff filter 85 based on the third cutoff frequency R based on the vehicle speed and the cutoff frequency set according to the degree of reliability of the calculation result attributed to the physical quantity relating to the frictional braking force by the evaluation gain. This allows the vehicle control apparatus 17 to realize the estimation with weight placed on the present correction gain reference value in the section where the reliability is high and on the previous output value of the variable cutoff filter in the section where the reliability is low by raising the cutoff frequency in the section where the reliability is high and lowering the cutoff frequency in the section where the reliability is low using the variable cutoff filter 85.

The cutoff frequency set according to the degree of reliability of the calculation result attributed to the physical quantity relating to the frictional braking force includes the first cutoff frequency Y set according to the degree of reliability of the calculation result attributed to the magnitude of the frictional braking force and the second cutoff frequency W set according to the degree of reliability of the calculation result attributed to the change speed of the frictional braking force. The error from the true value is highly likely to increase as the frictional braking force reduces, and the error increases due to a delay in the response of the G sensor 5 when the change speed of the frictional braking force is high. Therefore, the increase in the estimation error of the frictional braking force can be suppressed by setting the cutoff frequency according to the magnitude of the frictional braking force and the change speed of the frictional braking force.

The third cutoff frequency R based on the vehicle speed is set to increase as the speed increases. The first cutoff frequency Y based on the magnitude of the frictional braking force is set to increase as the frictional braking force increases. The second cutoff frequency W based on the change speed of the frictional braking force is set to increase as the change speed reduces. This allows the brake control apparatus 17 to realize the estimation with weight placed on the previous output value of the variable cutoff filter in the period during which the reliability is low, thereby suppressing the increase in the estimation error of the frictional braking force.

The cutoff frequency of the variable cutoff filter 85 is set by selecting the lowest of the cutoff frequency based on the vehicle speed, the cutoff frequency based on the frictional braking force, and the cutoff frequency based on the change speed of the frictional braking force. Selecting the cutoff frequency according to the select-low principle can suppress an increase in the estimation error due to estimation with weight placed on the present correction gain reference value despite the section where the reliability is low.

The physical quantity relating to the temperature of the frictional brake 3 is the temperature of the brake pad. The pad μ depends on the pad temperature. Then, when the pad temperature less changes since when the frictional braking has been applied previously, it is expected that heavy use of the previously estimated output value of the reliability evaluation filter also keeps the error small. On the other hand, when the pad temperature largely changes, it is expected that the error increases between the true value and the previously estimated output value of the reliability evaluation filter. Therefore, an increase in the braking distance due to the error between the estimated correction gain and the true value can be suppressed by changing the reliability gain according to the pad temperature change.

The reliability evaluation gain set according to the degree of reliability of the calculation result attributed to the physical quantity relating to the frictional braking force includes the first reliability evaluation gain M based on the magnitude of the frictional braking force and the second reliability evaluation gain N based on the change speed of the frictional braking force. When the frictional braking force is small, the ride comfort is not affected so much even without intervention by the anti-jerk control, and, along therewith, the estimation error is highly likely to increase under the influence of a disturbance. Further, when the change speed of the frictional braking force is high, the error between the estimated correction gain and the true value may increase due to a stop of the update by the reliability evaluation filter portion 73. Therefore, an increase in the braking distance due to the error between the estimated correction gain and the true value can be suppressed by setting the reliability evaluation gain according to the magnitude of the frictional braking force and the change speed of the frictional braking force.

The first reliability evaluation gain M based on the magnitude of the frictional braking force is set to increase as the frictional braking force increases. The second reliability evaluation gain N based on the change speed of the frictional braking force is set to increase as the change speed of the frictional braking force reduces. The third reliability evaluation gain Q based on the pad temperature change is set to increase as the pad temperature less changes since when frictional braking has been applied previously. This leads to a reduction in the reliability evaluation gain in the period during which the reliability is low, thereby contributing to suppressing an increase in the braking distance due to the error between the estimated correction gain and the true value.

The reliability evaluation gain is set by multiplying the first reliability evaluation gain M based on the magnitude of the frictional braking force by the gain acquired by selecting the higher of the second reliability evaluation gain N based on the change speed of the frictional braking force and the third reliability evaluation gain Q based on the pad temperature change. For example, when the brake pedal is pressed while the vehicle runs at a low speed, the frictional coefficient of the brake is expected not to change largely because, for example, the pad temperature less increases, but the second reliability evaluation gain N is contrarily minimized because of an increase in the change speed of the frictional braking force. In light thereof, selecting the higher of the second reliability evaluation gain N and the third reliability evaluation gain Q causes the third reliability evaluation gain Q to be selected when the brake pedal is pressed while the vehicle runs at a low speed, thereby contributing to preventing the reliability evaluation gain to be underestimated despite the section where the output value of the reliability evaluation filter maintains high reliability.

### Other Embodiments

Having described the embodiment for implementing the present invention, the specific configuration of the present invention is not limited to the configuration of the embodiment, and the present invention also includes a design modification and the like thereof made within a range that does not depart from the spirit of the present invention, if any.

The embodiment has been described citing the example in which the present invention is applied to the rear-wheel drive electric vehicle, but the present invention may also be applied to a front-wheel drive electric vehicle or a four-wheel drive electric vehicle. Further, without being limited to the electric vehicle, the present invention may also be applied to a vehicle equipped with an engine that is an internal combustion engine, or a hybrid vehicle runnable using both an engine and a motor. In other words, the present invention can be applied to any configuration capable of providing a torque from a drive source side or any configuration capable of reducing frictional brake within a range in which the vehicle can stop or a range in which a braking force works between a drive wheel and a road surface when the vehicle stops using the frictional brake.

The reliability evaluation filter portion 73 according to the first embodiment sets the cutoff frequency by selecting the lowest of the respective output values of the frequency maps 81 to 83, but may calculate the cutoff frequency by multiplying the respective output values of the frequency maps 81 to 83 together.

Further, the response of the G sensor value may be also delayed due to, for example, the change speed of the motor torque, and therefore a frequency map may be added for changing the cutoff frequency by referring to the change speed of the motor torque. Further, when the road surface can be deemed to be a bad-conditioned road, the estimation accuracy of the correction gain reference value may be impaired with noise added to the G sensor value, and therefore a frequency map may be added for changing the cutoff frequency according to a road surface disturbance (a road surface disturbance may be estimated by detecting the noise contained in the G sensor value using a high-pass filter or the like or may be detected by referring to information such as a stereo camera).

The upper limits of the three reliability evaluation gains M, N, and Q are preferably set to 1 in the reliability evaluation gain calculation portion 74 according to the first embodiment, but may be set to a value other than 1, and the lower limit values (M3, N3, and Q1) may also be set to zero. Further, the vehicle control apparatus 17 is configured to use each of the reliability evaluation gain maps 91 to 93 in the first embodiment, but may use a map for calculating the gain based on time elapsed since when the vehicle has been braked previously, a braking start speed, and a humidity because the humidity of the pad surface is also expected to affect the braking force.

Further, X1 and X2 in the cutoff frequency map 81 based on the magnitude of the frictional braking force and the reliability evaluation gain map 91 based on the magnitude of the frictional braking force, and Z1 and Z2 in the cutoff frequency map 82 based on the change speed of the frictional braking force and the reliability evaluation gain map 92 based on the change speed of the frictional braking force are indicated using the same variables in the embodiment, but may be indicated by using different values, respectively.

The present invention shall not be limited to the above-described embodiment, and includes various modifications. For example, the above-described embodiment has been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2022-138913 filed on Sep. 1, 2022. The entire disclosure of Japanese Patent Application No. 2022-138913 filed on Sep. 1, 2022 including the specification, the claims, the drawings, and the abstract is incorporated herein by reference in its entirety.

REFERENCE SIGNS LIST
1 electric vehicle (vehicle)
3 frictional brake (frictional braking apparatus)
7 rear motor (driving apparatus)
17 vehicle control apparatus (control portion)

1. A vehicle control apparatus mounted on a vehicle, the vehicle including a frictional braking apparatus configured to generate a frictional braking force on the vehicle and a driving apparatus configured to generate a driving force on the vehicle, the vehicle control apparatus comprising:
a control portion configured to output a result calculated based on input information,
the control portion being configured to
acquire a physical quantity relating to a total braking force for decelerating the vehicle, and
correct a control instruction for generating the driving force by the driving apparatus according to a degree of reliability of a calculation result attributed to a state of the vehicle and output the control instruction, in a state that the frictional braking force is generated at the time of deceleration of the vehicle based on the physical quantity relating to the total braking force.

2. The vehicle control apparatus according to claim 1, wherein the control portion corrects the control instruction according to the degree of reliability of the calculation result attributed to the state of the vehicle that includes at least a physical quantity relating to a speed of the vehicle, a physical quantity relating to a target frictional braking force of the vehicle, and a physical quantity relating to a temperature of the frictional braking apparatus.

3. The vehicle control apparatus according to claim 2, wherein the control portion
determines a final correction gain by multiplying an output value resulting from correcting a predetermined correction gain reference value according to the degree of reliability of the calculation result attributed to the physical quantity relating to the speed of the vehicle and the degree of reliability of the calculation result attributed to the physical quantity relating to the target frictional braking force by an evaluation gain acquired based on a gain set according to the degree of reliability of the calculation result attributed to the physical quantity relating to the target frictional braking force and a gain set according to the degree of reliability of the calculation result attributed to the physical quantity relating to the temperature of the frictional braking apparatus, and
corrects the control instruction based on the final correction gain.

4. The vehicle control apparatus according to claim 3, wherein the control portion determines the final correction gain by multiplying the output value resulting from filtering the predetermined correction gain reference value through a variable cutoff filter based on a cutoff frequency set according to the degree of reliability of the calculation result attributed to the physical quantity relating to the speed of the vehicle and a cutoff frequency set according to the degree of reliability of the calculation result attributed to the physical quantity relating to the target frictional braking force by the evaluation gain.

5. The vehicle control apparatus according to claim 4, wherein the cutoff frequency set according to the degree of reliability of the calculation result attributed to the physical quantity relating to the target frictional braking force includes a cutoff frequency set according to the degree of reliability of the calculation result attributed to magnitude of the target frictional braking force and a cutoff frequency set according to the degree of reliability of the calculation result attributed to a change speed of the target frictional braking force.

6. The vehicle control apparatus according to claim 5, wherein the cutoff frequency set according to the degree of reliability of the calculation result attributed to the physical quantity relating to the speed of the vehicle is set to increase as the speed increases,
wherein the cutoff frequency set according to the degree of reliability of the calculation result attributed to the magnitude of the target frictional braking force is set to increase as the target frictional braking force increases, and
wherein the cutoff frequency set according to the degree of reliability of the calculation result attributed to the change speed of the target frictional braking force is set to increase as the change speed reduces.

7. The vehicle control apparatus according to claim 6, wherein the cutoff frequency of the variable cutoff filter is set by selecting the lowest of the cutoff frequency set according to the degree of reliability of the calculation result attributed to the physical quantity relating to the speed of the vehicle, the cutoff frequency set according to the degree of reliability of the calculation result attributed to the magnitude of the target frictional braking force, and the cutoff frequency set according to the degree of reliability of the calculation result attributed to the change speed of the target frictional braking force.

8. The vehicle control apparatus according to claim 3, wherein the physical quantity relating to the temperature of the frictional braking apparatus is a temperature of a brake pad.

9. The vehicle control apparatus according to claim 8, wherein the gain set according to the degree of reliability of the calculation result attributed to the physical quantity relating to the target frictional braking force includes a gain set according to the degree of reliability of the calculation result attributed to the magnitude of the target frictional braking force and a gain set according to the degree of reliability of the calculation result attributed to the change speed of the target frictional braking force.

10. The vehicle control apparatus according to claim 9, wherein the gain set according to the degree of reliability of the calculation result attributed to the magnitude of the target frictional braking force is set to increase as the target frictional braking force increases,
wherein the gain set according to the degree of reliability of the calculation result attributed to the change speed of the target frictional braking force is set to increase as the change speed reduces, and
wherein the gain set according to the degree of reliability of the calculation result attributed to the temperature of the brake pad is set to increase as a change amount of the temperature reduces.

11. The vehicle control apparatus according to claim 10, wherein the evaluation gain is set by multiplying the gain set according to the degree of reliability of the calculation result attributed to the magnitude of the target frictional braking force by a gain acquired by selecting the higher of the gain set according to the degree of reliability of the calculation result attributed to the change speed of the target frictional braking force and the gain set according to the degree of reliability of the calculation result attributed to the temperature of the brake pad.

12. The vehicle control apparatus according to claim 3, wherein the control portion determines the correction gain reference value based on the physical quantity relating to the target frictional braking force, the driving force of the driving apparatus, a longitudinal acceleration of the vehicle, running resistance of the vehicle, and a weight of the vehicle.

13. A vehicle control method configured to be performed by a control unit mounted on a vehicle, the vehicle including a frictional braking apparatus configured to generate a frictional braking force on the vehicle and a driving apparatus configured to generate a driving force on the vehicle, the vehicle control method comprising:
causing the control unit to
acquire a physical quantity relating to a total braking force for decelerating the vehicle, and
correct a control instruction for generating the driving force by the driving apparatus according to a degree of reliability of a calculation result attributed to a state of the vehicle and output the control instruction, in a state that the frictional braking force is generated at the time of deceleration of the vehicle based on the physical quantity relating to the total braking force.

14. A vehicle control system comprising:
a frictional braking apparatus configured to generate a frictional braking force on a vehicle;
a driving apparatus configured to generate a driving force on the vehicle; and
a control apparatus configured to output a result calculated based on input information, the control apparatus being configured to
acquire a physical quantity relating to a total braking force for decelerating the vehicle, and
correct a control instruction for generating the driving force by the driving apparatus according to a degree of reliability of a calculation result attributed to a state of the vehicle and output the control instruction, in a state that the frictional braking force is generated at the time of deceleration of the vehicle based on the physical quantity relating to the total braking force.
